(19) United States
(12) Patent Application Publication
(10) Pub. No.: US 2026/0367794 A1
(43) Pub. Date: Nov. 19, 2026

(54) High Performance XOR and Read Modify Write Operations

(71) Applicant: Sandisk Technologies, Inc., Milpitas, CA (US)

(72) Inventors: Atif HUSSAIN, Longmont, CO (US); Yossi Yoseph HASSAN, Nechusha (IL); Yuri RYABININ, Beer Sheva (IL)

(73) Assignee: Sandisk Technologies, Inc., Milpitas, CA (US)

(21) Appl. No.: 19/209,965

(22) Filed: May 16, 2025

(51) Int. Cl. G06F 3/06

(52) U.S. Cl. CPC G06F 3/0611; G06F 3/0659; G06F 3/0673

(57) ABSTRACT

Moving the location where read modify write (RMW) or exclusive OR (XOR) operations occur will reduce latency. On the RMW side of things, the fetched read data and the modification can be provided in parallel to a RMW module. The RMW module is at a location closer to the memory device and further away from the processor or hardware (HW) engine where modification operations typically occur. Thus, the modification occurs closer to the location where the write will occur and latency will be reduced. Similarly, on the XOR side of things, the XOR operation occurs at an XOR module that is at a location closer to the memory device and further away from the processor or encoder where XOR operations typically occur. Thus, the XOR operation occurs closer to the location where the write will occur and latency will be reduced.

### BACKGROUND OF THE DISCLOSURE

### Field of the Disclosure

Embodiments of the present disclosure generally relate to improving exclusive OR (XOR) and read modify write (RMW) operations.

### Description of the Related Art

Data storage devices are used to store data for a host device. The host device will often send new data to the controller of the data storage device to be written to a memory device of the data storage device. The host device will also send read commands to the controller to instruct the controller to read data from the memory device and provide the data back to the host device.

Read modify write (RMW) operations have a high latency. RMW operations involve three stages of operation and thus three paths are traversed. Previously, RMW operations were done by a processor or hardware (HW) engine by first reading the data from the memory device, waiting for the response data, modifying the response data internally at an initiator, and then finally writing the modified response data back out to the memory device.

Similar to RMW operations, exclusive OR (XOR) operations have a high latency in that software (SW) or HW has to first read from a location, wait for the result, modify the result internally, and finally write the result back out. XOR operations involve three stages of operation, and three paths are traversed over a chip. Previously, XOR operations were done by a processor or HW engine by first reading the data from the memory device, waiting for the response data, executing the XOR operation internally at the initiator, and then finally writing the XOR data back out to the memory device. A standalone encoder or data processing module reads via a data source port and an XOR source via an XOR source port. Then an XOR is executed and written to the same XOR address, from which XOR source data was read, via the XOR destination port.

In both RMW operations and XOR operations, latency is a problem. Therefore, there is a need in the art for improving XOR and RMW operations.

### SUMMARY OF THE DISCLOSURE

Moving the location where read modify write (RMW) or exclusive OR (XOR) operations occur will reduce latency. On the RMW side of things, the fetched read data and the modification can be provided in parallel to a RMW module. The RMW module is at a location closer to the memory device and further away from the processor or hardware (HW) engine where modification operations typically occur. Thus, the modification occurs closer to the location where the write will occur and latency will be reduced. Similarly, on the XOR side of things, the XOR operation occurs at an XOR module that is at a location closer to the memory device and further away from the processor or encoder where XOR operations typically occur. Thus, the XOR operation occurs closer to the location where the write will occur and latency will be reduced.

In one embodiment, a data storage device comprises: a memory device; and a controller coupled to the memory device, wherein the controller is configured to: determine whether a RMW operation or an XOR operation is to be performed, wherein the controller comprises a processor and an encoder; and execute the RMW operation or the XOR operation at a location separate and distinct from the processor and the encoder.

In another embodiment, a data storage device comprises: a memory device; and a controller coupled to the memory device, wherein the controller is configured to: read data from the memory device; deliver the read data to a RMW module, wherein the RMW module is separate and distinct from a processor; deliver modification information to the RMW module; modify the read data with the modification information; and write the modified read data to the memory device.

In another embodiment, a data storage device comprises: means to store data; and a controller coupled to the means to store data, wherein the controller is configured to: read source data from a first memory location of the means to store data; deliver the source data to an encode and a direct memory access (DMA) module; send the source data to an XOR module; read XOR source data from a second memory location of the means to store data; XOR the XOR source data and the source data; and write the XOR’d data to the second memory location.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a schematic illustration of a read modify write (RMW) operation according to one embodiment.

FIG. 3 is a flowchart illustrating the RMW operation of FIG. 2.

FIG. 4 is a schematic illustration of a RMW operation according to another embodiment.

FIG. 5 is a flowchart illustrating the RMW operation of FIG. 4.

FIG. 6 is a schematic illustration of an exclusive OR (XOR) operation according to one embodiment.

FIG. 7 is a flowchart illustrating the XOR operation of FIG. 6.

FIG. 8 is a schematic illustration of an XOR operation according to another embodiment.

FIG. 9 is a flowchart illustrating the XOR operation of FIG. 8.

FIG. 10 is a flowchart illustrating a data processing operation according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Moving the location where read modify write (RMW) or exclusive OR (XOR) operations occur will reduce latency. On the RMW side of things, the fetched read data and the modification can be provided in parallel to a RMW module. The RMW module is at a location closer to the memory device and further away from the processor or hardware (HW) engine where modification operations typically occur. Thus, the modification occurs closer to the location where the write will occur and latency will be reduced. Similarly, on the XOR side of things, the XOR operation occurs at an XOR module that is at a location closer to the memory device and further away from the processor or encoder or data processing module where XOR operations typically occur. Thus, the XOR operation occurs closer to the location where the write will occur and latency will be reduced.

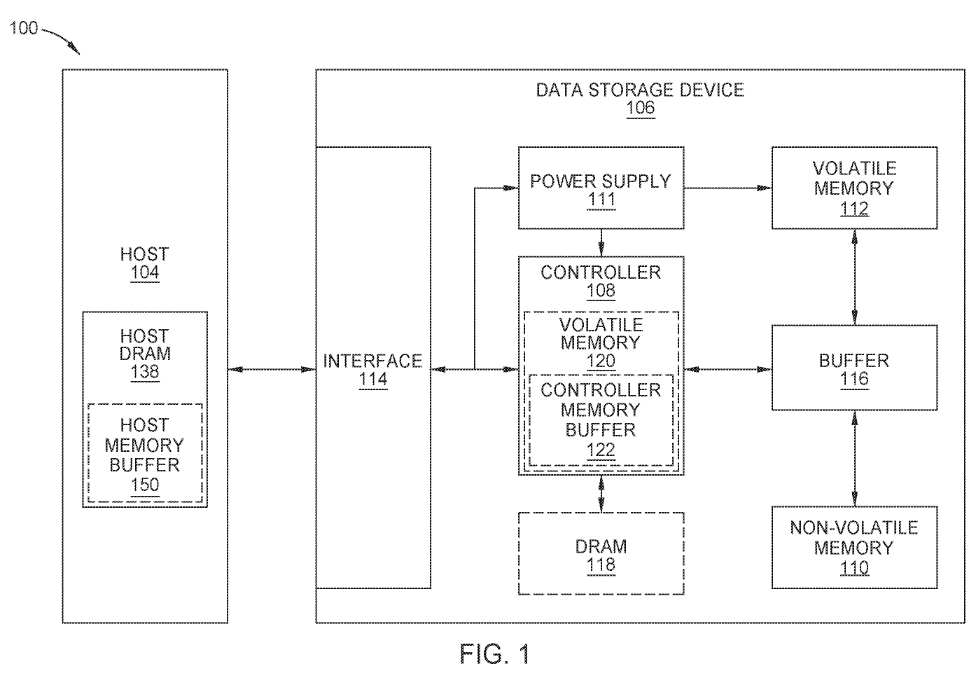

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5” data storage device (e.g., an HDD or SSD), 2.5” data storage device, 1.8” data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128MB, 256MB, 512MB, 1GB, 2GB, 4GB, 8GB, 16GB, 32GB, 64GB, 128GB, 256GB, 512GB, 1TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110. Controller 108 may include circuitry or processors configured to execute programs for operating the data storage device 106.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

For a RMW operation, there are descriptors, and the descriptors have to be updated relatively continuously for operations to the memory device. The descriptors hold control information such as the address from where to read the data and/or the bits in the location that need to be modified. The descriptors are read, updated, and written back. The FW uses prebuild descriptors so as to avoid creating descriptors from scratch. Thus, the FW reads the descriptors, changes the descriptors, and writes back the changed descriptors. The descriptors continuously build based upon what work is occurring. Generally speaking, the processor will update the descriptor. For example, initially there is a base descriptor and the processor changes some parts of the base descriptor. Historically, the descriptor is read, updated, and then written back. Then, based upon another read, the process repeats which causes latency.

There are two parts to a command, a control part and a data part, in which case a command can be transferred via the same interface as the data. The data part is the payload written to the memory device or read from the memory device. For the control part of the command, which is the actual command, the goal is to make the control part as small as possible because the control part is wasted time. Generally speaking, users care about how fast the controller can transfer data in or out, and thus the control portion should be completed as fast as possible because the data portion is what the user really cares about.

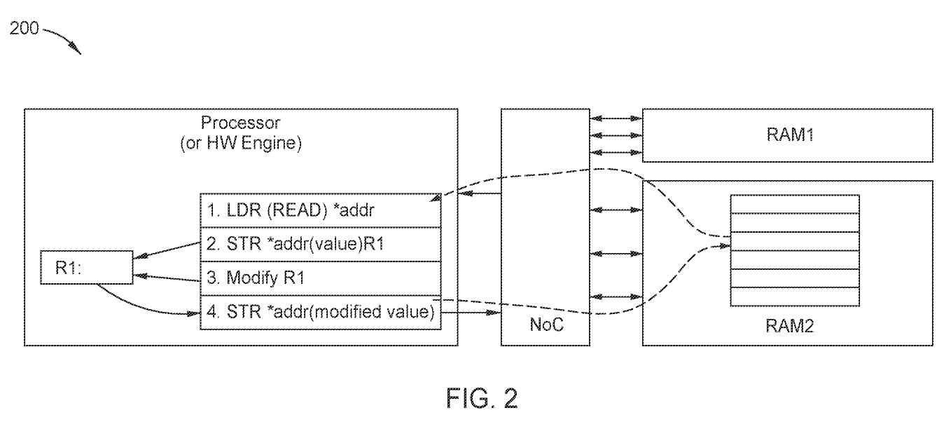

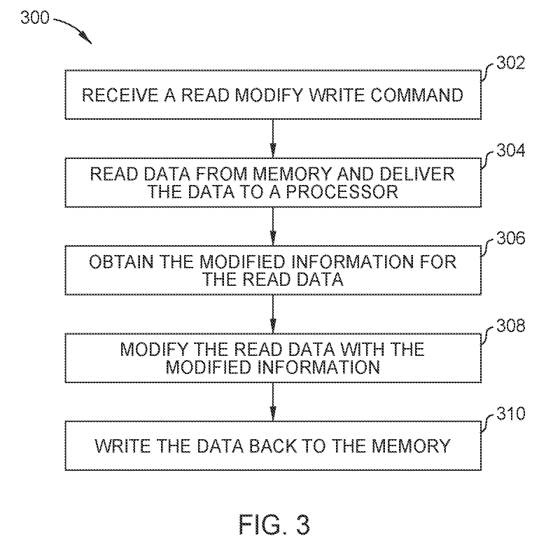

FIG. 2 is a schematic illustration 200 of a RMW operation according to one embodiment. FIG. 3 is a flowchart 300 illustrating the RMW operation of FIG. 2. In FIG. 2, there is a processor or HW engine that processes the RMW command. There are also two memory locations shown, RAM 1 and RAM 2, as well as a network on chip (NoC) between the memory locations and processor. For the RMW operation, the data is first fetched from one of the memory locations and delivered to the processor via the NoC. The processor has the modification information and supplies both the modification and the fetched data to the modification module that is disposed in the processor. The modification module then modifies the fetched data followed by the processor delivering the modified data to the memory location so that the modified data is then written to the memory device. In one embodiment, the modified data is written to the same location from which the data was fetched.

In the flowchart 300, the process begins by receiving a RMW command at block 302 followed by reading the data from the memory and delivering the data to the processor at block 304. Thereafter, the modification is obtained at block 306 for the read data. The read data is then modified with the modification at block 308 followed by writing the now modified data to the memory device at block 310.

Instead of doing all the RMW operation of FIGS. 2 and 3, it would be beneficial to perform the modification at the destination. Performing the RMW at the destination means using a special command in the processor that provides the processor with the address of data and the modification to be made. Then, the HW at the memory location on the other side of the NoC recognizes the command and does the work. Because everything is done in one shot, technically one command or instruction, the process is faster.

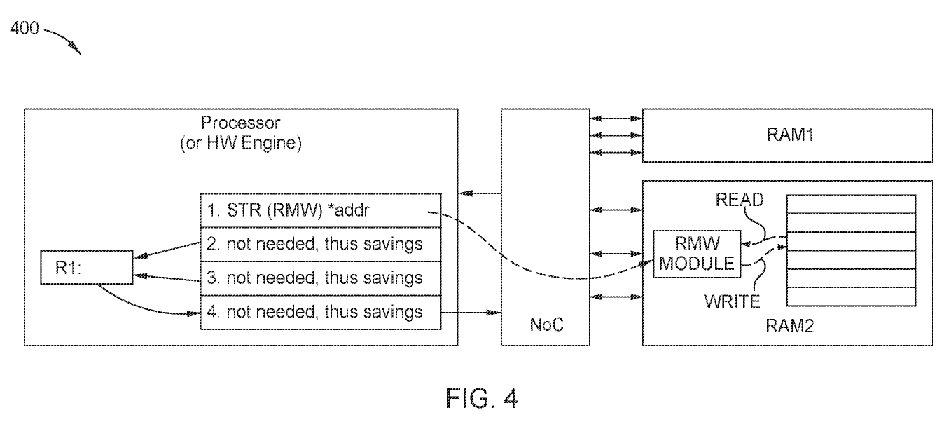

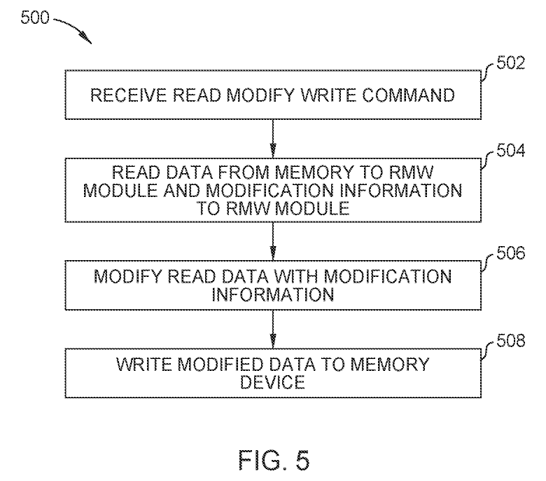

FIG. 4 is a schematic illustration 400 of a RMW operation according to another embodiment. FIG. 5 is a flowchart 500 illustrating the RMW operation of FIG. 4. As shown in FIG. 4, the processor or HW engine has a specialized opcode to instruct a HW module (or specialized intermediate module in a NoC) to execute a RMW. The opcode (instead of a simple read or write), instructs the final target (e.g., memory device) or intermediate module (e.g., NoC) to execute the RMW. The RMW module in HW, either at the target or an intermediate block in the HW path of the transaction can execute the operation. For example, the HW block is part of the interconnect, the NoC, or part of the final target module (i.e., memory device). Suitable final target modules include a register block wrapper or part of the memory's wrapper. The opcode can be translated to a command on the interface bus to the system.

For example, on a bus protocol for interfaces based matters: a RMW to be done on a 32bit register or memory location; the write byte enable (WBE) (i.e., byte strobe) is ignored and thus assumed to be all ones; the write data value is used to indicate which bits are to be modified; and the new command (aka opcode) in the command indicates a RMW is to be performed. The value on the last two bits of address used by the processor (via FW) or by the HW engine (based on a descriptor or command to the HW engine) indicates: bit modification to 0, bit modification to 1, bit modification to flip.

In the FIG. 4, the flow of instruction 1, 2, 3, and 4, the opcode in instruction 1 utilizes store register to register/memory (STR) RMW instead of load register from memory (LDR) -> STR -> Modify -> STR. Only 1 instruction is used instead of 4. The STR RMW would be a new instruction in the SW/FW. For data storage device that have not yet added support for the new opcode, the RMW is done by writing a special register at the target. The RMW operations are done by the target itself in HW. A write to the register of the data value indicates which bits are to be modified. The address least significant bits (LSBs) indicate if the bit modification to 0, bit modification to 1, or bit modification to flip. Previously the descriptors got bigger and bigger and bigger. With the new instruction, there is a little bit extra HW, but much better performance.

In FIG. 4, there is a processor or HW engine. There are also two memory locations shown, RAM 1 and RAM 2, as well as a NoC between the memory locations and processor. For the RMW operation, the data is first fetched from one of the memory locations and delivered to the RMW module in the memory device. The processor has the modification information and supplies the modification information to the RMW module. The RMW module then modifies the fetched data followed by delivering the modified data to the memory location so that the modified data is then written to the memory device. In one embodiment, the modified data is written to the same location from which the data was fetched.

In the flowchart 500, the process begins by receiving a RMW command at block 502 followed by reading the data from the memory and delivering the data to the RMW module as well as the modification information at block 504. Thereafter, the read data is then modified with the modification at block 506 followed by writing the now modified data to the memory device at block 508.

For XOR, the concept is very similar to RMW operations because an encoder is used instead of a processor. The XOR process involves reading the source data from a memory and bringing the data to the encoder and the XOR source data from another memory source, doing the XOR, and then sending the XOR’d data back to the XOR source location.

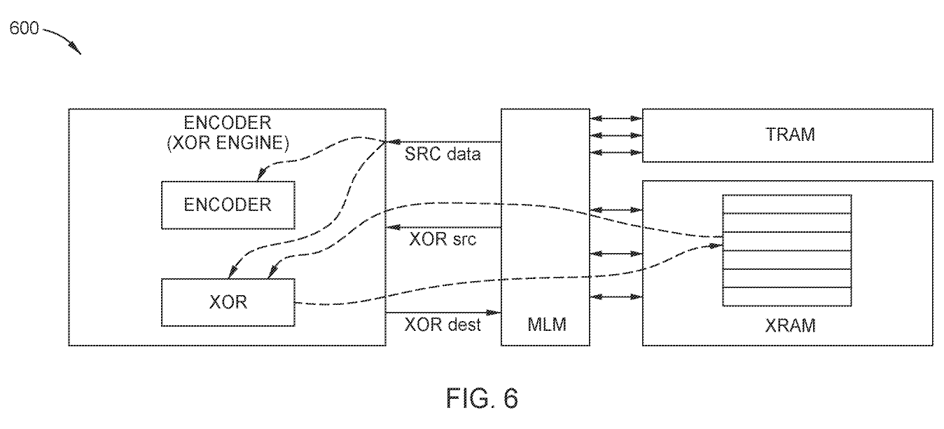

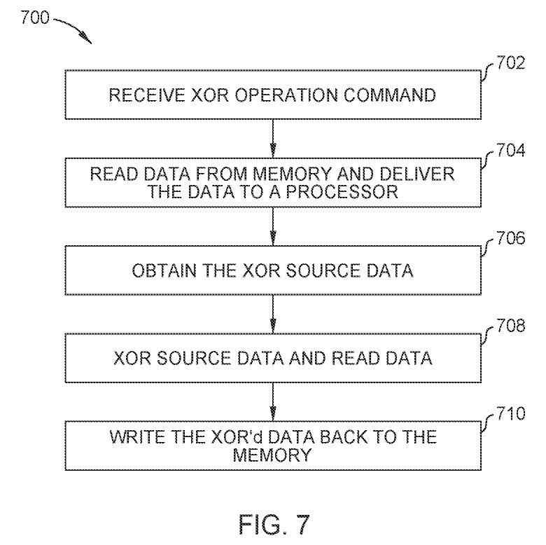

FIG. 6 is a schematic illustration 600 of an XOR operation according to one embodiment. FIG. 7 is a flowchart 700 illustrating the XOR operation of FIG. 6. FIG. 6 includes an encoder or encoder that comprises the encoder module and the XOR module. There is also a multi-layer matrix (MLM), which could be a NoC, and two memory locations exemplified TRAM, which is a staging SRAM, and an accelerator RAM (XRAM). The XOR source data is fetched from the memory location (e.g., XRAM) and the source data is fetched from the TRAM. The source data is provided to the encoder module and the XOR module. The XOR source data is provided to the XOR module. The XOR module then performs the XOR operation and provides the results back to the memory location (e.g., XRAM). More specifically, the process involves receiving an XOR operation command at block 702 followed by reading source data from the source and delivering the read data to the XOR module and encoder at block 704. The XOR source data is obtained and delivered to the XOR module at block 706. The source data and the XOR source data is XOR’d at block 708 followed by writing the XOR’d data to the memory device at block 710.

For lack of better words, the XOR operation for FIGS. 6 and 7 contain a wasted path. The encoder can be moved to a location closer to the memory. Instead of doing the XOR in the encoder or HW engine, the data is simply sent to the engine cluster that is closer to the memory which could be the memory or in the MLM which is closer to the memory. When the controller gets the source data coming into the encoder, based upon OP code and instruction, the controller knows that an XOR operation is to be performed. Therefore, in parallel the controller will send the source data out to the engine that closer to the memory device. The XOR module in the MLM will fetch the XOR source data from the memory device and then send the XOR’d data back.

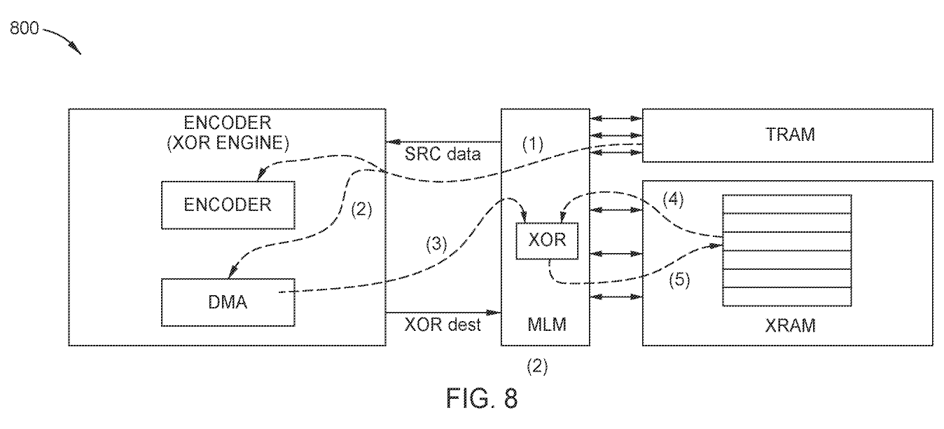

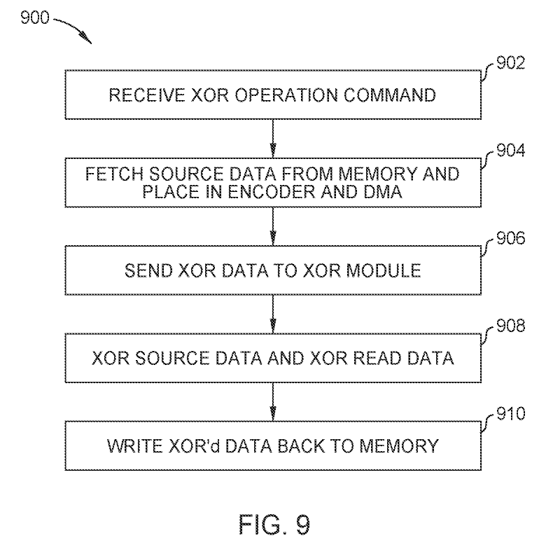

FIG. 8 is a schematic illustration 800 of an XOR operation according to another embodiment. FIG. 9 is a flowchart 900 illustrating the XOR operation of FIG. 8. A HW engine (or processor) has a specialized opcode to instruct a HW module (or specialized intermediate module in a network on chip) to execute an XOR. The opcode instructs the final target (or intermediate module) to execute the XOR operation. An XOR block in HW, either at the target or an intermediate block in the HW path of the transaction can execute the operation. In one embodiment, the XOR module can also be part of the memory's wrapper. The command (from SW or HW engine) as an opcode can be translated to a command on the interface bus to the system. For data storage devices that have not yet added support for the new opcode, the XOR is executed by commanding a special register at the target (i.e., memory device). The XOR operation is done by the target itself in HW.

The HW engine (or processor) will have only a source port and an XOR destination port. The processor engine will read source data and write source data immediately through the XOR destination port. The XOR module will internally execute a pipelined RMW operation onto the memory (XRAM) based on the special instruction (or opcode) sent by the processor engine. The encoder/encoder fetches the FMU source data. In one embodiment, the engine in FIG. 8 is an encoder, but the XOR operation is not actually done by the encoder. The XOR is just initiated by the encoder via a special opcode. A processor can also initiate the XOR using a special instruction.

In operation, the HW engine (or processor) forwards the data via a direct memory access (DM0A module to the XOR destination port. The HW engine sends (a write request) through the XOR destination port thus providing the XOR destination address (towards the XRAM). The XOR module does a XOR (i.e., RMW) to the destination address, and then sends a completion response for the write back to the HW engine. The Encoder will send the next write request until all writes are complete.

FIG. 8 includes an encoder or encoder that comprises the encoder module and a DMA module. There is also a MLM, which could be a NoC which contains the XOR module, and two memory locations exemplified as a TRAM and an XRAM. The XOR source data is fetched from the memory location (e.g., XRAM) and the source data is fetched from the other memory location. The source data is provided to the encoder module and the DMA module and then the XOR module. The XOR source data is provided to the XOR module. The XOR module then performs the XOR operation and provides the results back to the memory location (e.g., XRAM). More specifically, the process involves receiving an XOR operation command at block 902 followed by reading source data from the source and delivering the read data to the DMA module, encoder, and XOR module at block 904. The XOR source data is obtained and delivered to the XOR module at block 906. The source data and the XOR read data is XOR’d at block 908 followed by writing the XOR’d data to the memory device at block 910.

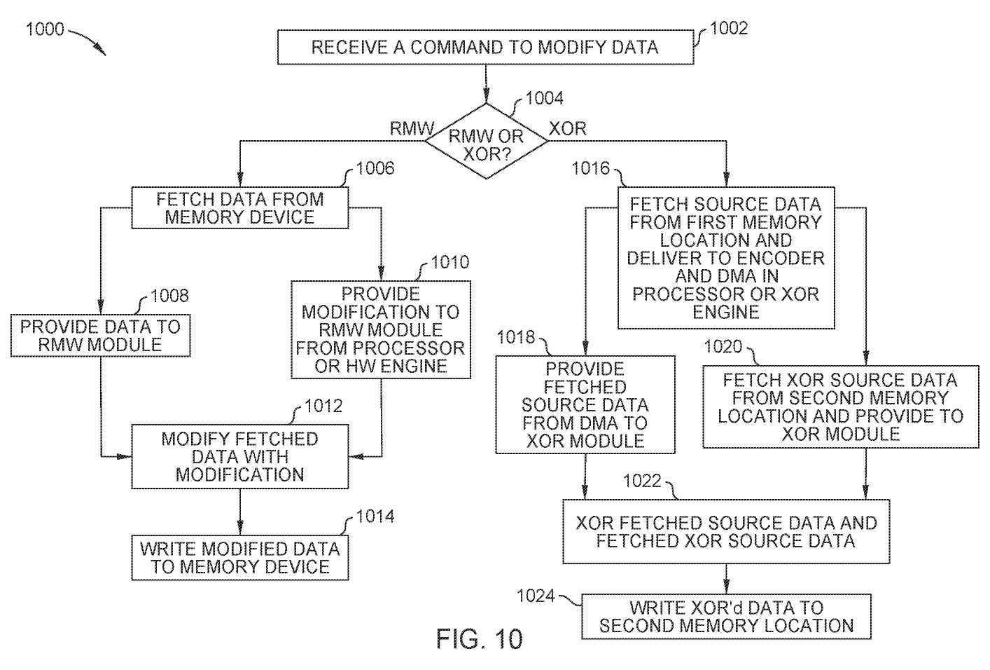

FIG. 10 is a flowchart 1000 illustrating a data processing operation according to one embodiment. The process begins by receiving a command to modify data at block 1002. Thereafter, a determination is made at block 1004 regarding whether the modification is a RMW operation command or an XOR operation command.

If the command is for a RMW operation, then data is fetched from the memory device at block 1006. In one embodiment, the memory device is a NVM memory device 110 as shown in FIG. 1. In another embodiment, the memory device is a volatile memory device 112 as shown in FIG. 1. If the memory device is a volatile memory device 112, in one embodiment, the memory device is divided into a plurality of portions such as RAM 1 and RAM 2 as shown in FIG. 4. The fetched data is provided to a RMW module at block 1008. In parallel to block 1008, the modification for the fetched data is provided to the RMW module from the processor or HW engine at block 1010. The RMW module is disposed in a location separate and distinct from a processor or HW engine and separate and distinct from a NoC. More specifically, the RMW module may be, in one embodiment, coupled directly to the memory device. In yet another embodiment, the RMW module is integral to the memory device such that the RMW module is a part of the memory device. Regardless, after the RMW module has both the modification and the fetched data, the RMW module modifies the fetched data with the modification at block 1012 and then writes the modified data to the memory device at block 1014. In one embodiment, the modified data is written to the exact location from where the fetched data was fetched. In another embodiment, the modified data is written to a different location from where the fetched data was fetched.

If the command is for an XOR operation, then source data is fetched from a first memory location of the memory device at block 1016 and delivered to an encoder and DMA of a processor or encoder. In one embodiment, the first memory location is a NVM memory device 110 as shown in FIG. 1. In another embodiment, the first memory location is a volatile memory device 112 as shown in FIG. 1. If the first memory location is a volatile memory device 112, in one embodiment, the first memory location is divided into a plurality of portions such as TRAM and XRAM 2 as shown in FIG. 8. In the embodiment shown in FIG. 8, the data is fetched from the TRAM. Thereafter, the fetched source data is provided from the DMA to the XOR module at block 1018. Simultaneously to block 1018, XOR source data is fetched from a second memory location and provided to the XOR module at block 1020. Similar to the description above, in one embodiment, the second memory location is a NVM memory device 110 as shown in FIG. 1. In another embodiment, the second memory location is a volatile memory device 112 as shown in FIG. 1. If the memory device is a volatile memory device 112, in one embodiment, the memory device is divided into a plurality of portions such as TRAM and XRAM as shown in FIG. 8. In the embodiment shown in FIG. 8, the XOR source data is fetched from the XRAM. Thereafter, the XOR fetched source data and the fetched source data provided by the DMA are XOR’d at block 1022 followed by writing the XOR’d data to the second memory location. In one embodiment, the XOR’d data is written to the exact location from where the fetched XOR source data was fetched. In another embodiment, the XOR’d data is written to a different location from where the fetched XOR source data was fetched. It is to be noted that the encoder and the XOR module are separate and distinct elements in separate and distinct locations. The XOR module is disposed at a location remote from the processor or encoder. In one embodiment, the XOR module is disposed in the MLM or NoC. In another embodiment, the XOR module may be coupled directly to the memory device. In yet another embodiment, the XOR module is integral to the memory device such that the XOR module is a part of the memory device.

By performing RMW operations at the memory device or away from the processor, latency is cut by one third of time which is valuable in control path latency sensitive operations. Similarly, by performing XOR operations away from the processor or encoder, the latency and bandwidth is cut by one third time which is valuable in latency sensitive operations that have to traverse across a chip using large amounts of memory because the XOR operation is normally done on large amounts of data. Thus, moving the location for the RMW module and XOR module improves XOR and RMW operations.

In one embodiment, a data storage device comprises: a memory device; and a controller coupled to the memory device, wherein the controller is configured to: determine whether a RMW operation or an XOR operation is to be performed, wherein the controller comprises a processor and an encoder; and execute the RMW operation or the XOR operation at a location separate and distinct from the processor and the encoder. The controller is configured to perform the following upon determining a RMW operation is to be performed: read data from the memory device; provide the read data to a RMW module; provide modification information to the RMW module; modify the read data with the modification information; and write the modified read data to the memory device. The modifying occurs in a RMW module. The RMW module is disposed in the memory device. The providing the read data and providing the modification information occurs in parallel. The writing is to a same location in the memory device from where the data was read. The controller is configured to perform the following upon determining an XOR operation is to be performed: read source data from a first location of the memory device; provide the read source data to a XOR module that is separate and distinct from the encoder; read XOR source data from a second location of the memory device; XOR the read source data and the read XOR source data; and write the XOR’d data to the memory device. The providing the read source data and fetching the XOR source data occurs in parallel. The writing is to the second location. The source data is provided to the XOR module from a DMA module in the encoder.

In another embodiment, a data storage device comprises: a memory device; and a controller coupled to the memory device, wherein the controller is configured to: read data from the memory device; deliver the read data to a RMW module, wherein the RMW module is separate and distinct from a processor; deliver modification information to the RMW module; modify the read data with the modification information; and write the modified read data to the memory device. The modification information is delivered from the processor. The modification information is delivered through a NoC to the RMW module. The RMW module is coupled to the memory device. The modified read data is written to a same location from where the data is read from the memory device.

In another embodiment, a data storage device comprises: means to store data; and a controller coupled to the means to store data, wherein the controller is configured to: read source data from a first memory location of the means to store data; deliver the source data to an encode and a DMA module; send the source data to an XOR module; read XOR source data from a second memory location of the means to store data; XOR the XOR source data and the source data; and write the XOR’d data to the second memory location. The first memory location is TRAM and the second location is XRAM. The encoder and the DMA module are disposed in an encoder that is separate and distinct from the XOR module. Sending the source data to an XOR module and reading the XOR source data occurs in parallel. The XOR module is disposed in a NoC.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
determine whether a read modify write (RMW) operation or an exclusive OR (XOR) operation is to be performed, wherein the controller comprises a processor and an encoder; and
execute the RMW operation or the XOR operation at a location separate and distinct from the processor and the encoder.

2. The data storage device of claim 1, wherein the controller is configured to perform the following upon determining a RMW operation is to be performed:
read data from the memory device;
provide the read data to a RMW module;
provide modification information to the RMW module;
modify the read data with the modification information; and
write the modified read data to the memory device.

3. The data storage device of claim 2, wherein the modifying occurs in a RMW module.

4. The data storage device of claim 3, wherein the RMW module is disposed in the memory device.

5. The data storage device of claim 4, wherein the providing the read data and providing the modification information occurs in parallel.

6. The data storage device of claim 5, wherein the writing is to a same location in the memory device from where the data was read.

7. The data storage device of claim 1, wherein the controller is configured to perform the following upon determining an XOR operation is to be performed:
read source data from a first location of the memory device;
provide the read source data to a XOR module that is separate and distinct from the encoder;
read XOR source data from a second location of the memory device;
XOR the read source data and the read XOR source data; and
write the XOR’d data to the memory device.

8. The data storage device of claim 7, wherein the providing the read source data and fetching the XOR source data occurs in parallel.

9. The data storage device of claim 8, wherein the writing is to the second location.

10. The data storage device of claim 9, wherein the source data is provided to the XOR module from a direct memory access (DMA) module in the encoder.

11. A data storage device, comprising:
a memory device; and
a controller coupled to the memory device, wherein the controller is configured to:
read data from the memory device;
deliver the read data to a read modify write (RMW) module, wherein the RMW module is separate and distinct from a processor;
deliver modification information to the RMW module;
modify the read data with the modification information; and
write the modified read data to the memory device.

12. The data storage device of claim 11, wherein the modification information is delivered from the processor.

13. The data storage device of claim 12, wherein the modification information is delivered through a network on chip (NoC) to the RMW module.

14. The data storage device of claim 13, wherein the RMW module is coupled to the memory device.

15. The data storage device of claim 11, wherein the modified read data is written to a same location from where the data is read from the memory device.

16. A data storage device, comprising:
means to store data; and
a controller coupled to the means to store data, wherein the controller is configured to:
read source data from a first memory location of the means to store data;
deliver the source data to an encode and a direct memory access (DMA) module;
send the source data to an exclusive OR (XOR) module;
read XOR source data from a second memory location of the means to store data;
XOR the XOR source data and the source data; and
write the XOR’d data to the second memory location.

17. The data storage device of claim 16, wherein the first memory location is TRAM and the second location is XRAM.

18. The data storage device of claim 16, wherein the encoder and the DMA module are disposed in an encoder that is separate and distinct from the XOR module.

19. The data storage device of claim 16, wherein sending the source data to an XOR module and reading the XOR source data occurs in parallel.

20. The data storage device of claim 16, wherein the XOR module is disposed in a network on chip (NoC).
